(19) United States
(12) Patent Application Publication
(10) Pub. No.: US 2015/0114315 A1
(43) Pub. Date: Apr. 30, 2015

(54) EVAPORATOR-FEEDER SYSTEM AND METHOD

(71) Applicant: AMPAC Fine Chemicals LLC, Rancho Cordova, CA (US)

(72) Inventors: Brian C. LIPPSMEYER, Roseville, CA (US); Grant M. GONTARSKI, Citrus Heights, CA (US); Ryan P. THIBAULT, Citrus Heights, CA (US); Ben L. BENNING, Cameron Park, CA (US)

(73) Assignee: AMPAC FINE CHEMICALS LLC, Rancho Cordova, CA (US)

(21) Appl. No.: 14/068,519

(22) Filed: Oct. 31, 2013

(51) Int. Cl. F17C 9/02; F22B 1/02

(52) U.S. Cl. CPC F17C 9/02; F22B 1/021; F17C 2221/012; F17C 2221/013; F17C 2221/014; F17C 2227/0309; F17C 2250/0421; F17C 2270/05
USPC 122/15.1

(57) ABSTRACT

A method for releasing an anhydrous gas in a gas phase at a target rate includes the step of obtaining a vessel at least partially filled with the anhydrous gas. The anhydrous gas is at least partially in a liquid phase and the vessel has an outlet for releasing the anhydrous gas in the gas phase. The method further includes releasing at least a portion of the anhydrous gas from the vessel through the outlet in the gas phase; applying a heat transfer fluid having a temperature of 32° F. to 150° F. to an exterior surface of the vessel during the releasing step, such that the anhydrous gas in the liquid phase is evaporated and the anhydrous gas in the gas phase is released at the target rate; and measuring starting and end weights of the vessel to monitor the releasing of the anhydrous gas in the gas phase.

### BACKGROUND OF THE INVENTION

Anhydrous gases, such as anhydrous halogen gases, are widely used in the chemical industry. For example, hydrogen bromide (HBr) is utilized in the production of inorganic bromides by reaction with metal hydroxides, oxides, or carbonates; in the production of organic bromides by reaction with alkyl alcohols or alkenes; as a catalyst for oxidations, alkylations, and condensations in organic chemistry, and for etching applications in the semiconductor manufacturing industry.

HBr is typically supplied or shipped as a liquid, and more particularly a liquefied gas under its own vapor pressure (i.e., 297 psia or 2,048 kPa absolute) at 70° F. (21.1° C.), in a vessel. Liquefied gases are gases that transform to the liquid phase at normal temperatures inside a pressurized gas vessel. The liquid HBr is evaporated to a gas within the HBr vessel and the resulting anhydrous gaseous HBr is then fed to a reactor for use in various applications, such as those described above. Generally, it is desirable to have a rapid evaporation and flow of gaseous HBr from the cylinder to the reactor in order to minimize the overall process cycle time.

There are various known systems to facilitate evaporation of a liquid gas within a vessel and supply of the gaseous gas from the vessel to a reactor. In one known system, ambient air is utilized to heat the exterior of the vessel containing the liquid HBr when the gaseous HBr is fed from the vessel to the reactor. The heat of the ambient air is transferred through the wall of the HBr vessel to the liquid HBr contained therein, thereby facilitating evaporation of the liquid HBr. The internal surface area of the vessel, the ambient air temperature, and the degree and efficiency of heat transfer between the ambient air and the vessel affect the evaporation rate of the HBr, thus the feed rate of the gaseous HBr from the vessel to the reactor. One drawback of such known systems is that, as some of the HBr evaporates into the gaseous state, the remaining liquid HBr cools, thereby resulting in a decreased rate of evaporation. As a result, the ambient air-heated HBr vessel cannot transfer the requisite amount of gaseous HBr to the reactor in a timely manner. More particularly, while the feed or transfer rate of such vessels is initially approximately 100 kg/hr or greater, the rate generally drops off to almost 0 kg/hr as the vessel's contents cool. Another drawback of ambient air-heated vessels is that liquid HBr is often left within the vessels and returned to the HBr vendor, which increases the overall raw material costs for a given campaign.

Another known system for evaporating liquid HBr involves passing the liquid HBr from the vessel through a heat exchanger, which has a greater surface area than that of the vessel, and using ambient air as a heating source. In turn, the evaporation rate of the HBr is increased. However, a drawback of such known systems is that they require additional transfer piping, which can become easily fouled by dissolved solids entrained within the liquid HBr. Accordingly, for this type of known system, it is necessary to utilize filters and/or periodically clean the transfer piping, which increases the overall process cycle time. Additionally, transfer of the liquid HBr to the heat exchanger requires additional controls and careful attention, thereby increasing the complexity and costs associated with the system, as compared with systems in which the HBr is evaporated within the vessel. Such known systems also suffer the drawback of increased raw material costs due to liquid HBr being left within the vessels.

Another known system involves direct heating of the vessel itself, such as by steam, electric blankets or heated solutions. Such a conventional vessel has a relief device built therein in order to prevent catastrophic over-pressurization of the vessel. Such conventional systems typically exhibit increased heat transfer and sufficient energy to meet the cycle time evaporation and feed flow rates. However, if the HBr vessel is overheated, the HBr vessel may generate increased pressure which causes the relief device to fail. Also, the direct heat may damage the relief device, resulting in a release of corrosive HBr gas from the vessel. Such damage to the relief device may occur during the actual feed period due to the evaporative effect of the HBr or even after the feed period, when the overall vessel temperature increases thereby making the vessel more susceptible to premature future failure. Accordingly, HBr vessel manufacturers typically do not recommend or permit customers to heat their vessels.

Accordingly, it would be desirable to provide an evaporator and feed system which allows for rapid and controlled formation and feeding of anhydrous gases.

### BRIEF SUMMARY OF THE INVENTION

The present invention is directed to a method for releasing an anhydrous gas in a gas phase at a target rate. The method comprises the step of obtaining a vessel at least partially filled with the anhydrous gas, the anhydrous gas being at least partially in a liquid phase and the vessel having an outlet for releasing the anhydrous gas in the gas phase. The method further comprises the steps of releasing at least a portion of the anhydrous gas from the vessel through the outlet in the gas phase; applying a heat transfer fluid having a temperature in the range of 32 to 150° F. to an exterior surface of the vessel during the releasing step, such that the anhydrous gas in the liquid phase is evaporated and the anhydrous gas in the gas phase is released at the target rate; and measuring a starting weight of the vessel and an end weight of the vessel to monitor the releasing of the anhydrous gas in the gas phase.

Another aspect of the present invention is directed to evaporator and feed system for releasing an anhydrous gas in a gas phase at a target rate. The system comprises a vessel at least partially filled with the anhydrous gas. The anhydrous gas is at least partially in a liquid phase and the vessel has an outlet for releasing the anhydrous gas in the gas phase. The system further comprises a scale assembly including a weight sensor. The vessel is positioned on and supported by a surface of the scale assembly, such that the scale assembly measures a weight of the vessel. The system further comprises a heating assembly for applying a heat transfer fluid having a temperature in the range of 32 to 150° F. to an exterior surface of the vessel during the releasing step, such that the anhydrous gas in the liquid phase is evaporated and the anhydrous gas in the gas phase is released at the target rate.

### BRIEF DESCRIPTION OF THE SEVERAL VIEWS OF THE DRAWINGS

The foregoing summary, as well as the following detailed description of the invention, will be better understood when read in conjunction with the appended drawings. These drawings are included for the purpose of illustrating a preferred embodiment of the invention. The invention is not limited to the precise arrangements and instrumentalities shown. In the drawings:

FIG. 1 is a schematic diagram of a preferred embodiment of a process for evaporating liquid HBr and feeding HBr vapor to a reactor;

FIG. 2 is a top perspective view of a cylinder positioned atop a scale assembly in accordance with a preferred embodiment of the present invention; and

FIG. 3 is a side elevational view of a evaporator and feed system in accordance with a preferred embodiment of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the evaporator and feed system and designated parts thereof. The terminology includes the above-listed words, derivatives thereof, and words of similar import. Additionally, the words “a” and “an”, as used in the claims and in the corresponding portions of the specification, mean “at least one.”

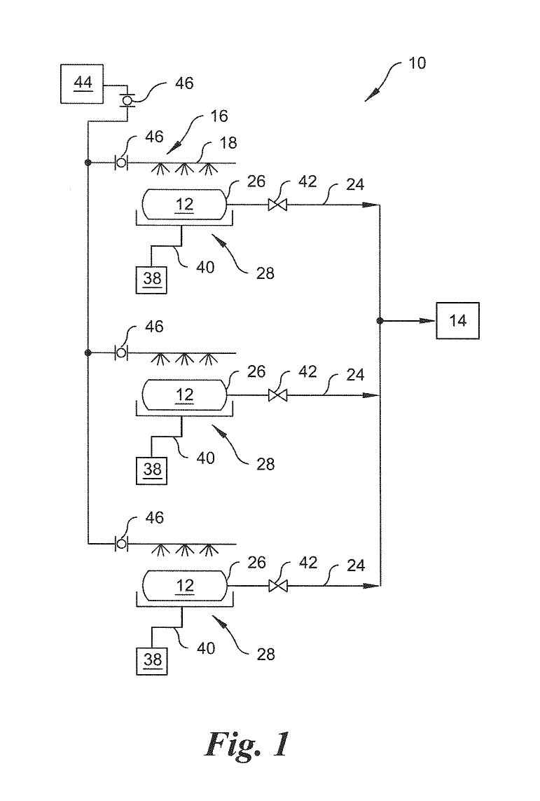

Referring to the drawings in detail, wherein like numerals and characters indicate like elements throughout, there is shown in FIGS. 1-3 a presently preferred embodiment of an evaporator and feed system in accordance with the present invention.

Referring particularly to FIG. 1, there is shown an evaporator and feed system, generally designated 10, for hydrogen bromide (HBr). It will be understood by those skilled in the art, that while the system and method of the present invention are described herein in the context of HBr, the system and method are equally applicable to any anhydrous gas, and particularly to any halogen gases (such as hydrogen chloride, hydrogen fluoride, hydrogen iodide and the like), a CO₂, a H₂, a O₂, a N₂, a HS and the like.

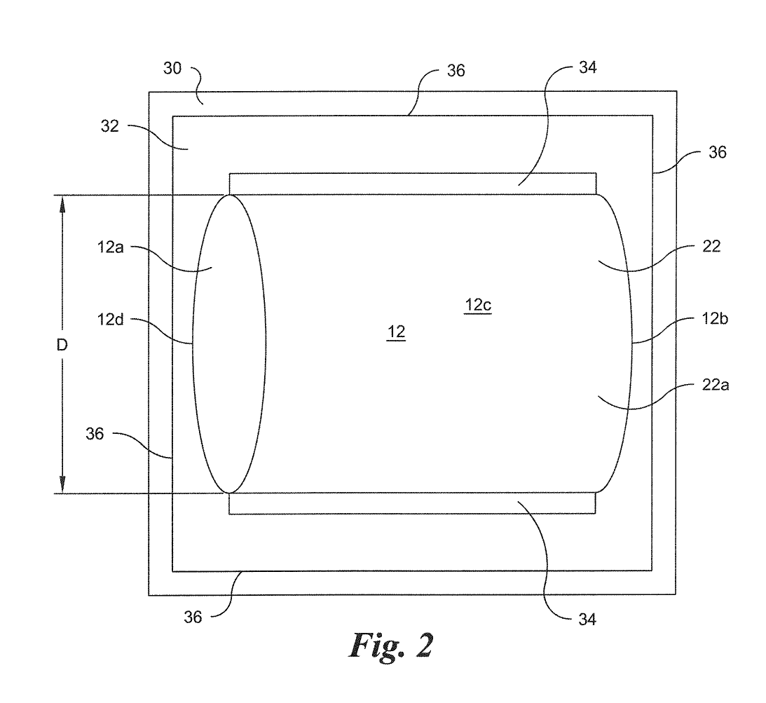

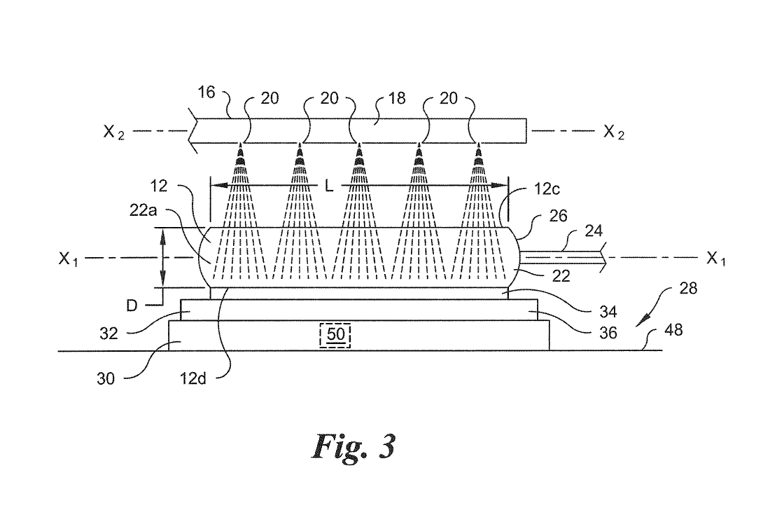

The system 10 includes a first vessel 12 and a second vessel 14. The first vessel 12 is preferably an evaporator vessel or evaporator, and the second vessel 14 is preferably a reaction vessel or reactor located downstream of the evaporator 12. Referring to FIG. 2, more preferably, the evaporator 12 is in the form of a generally tubular and closed pressure cylinder 12 including a first, generally closed end 12a, a second, generally closed end 12b, and a generally tubular sidewall 22 extending therebetween. The cylinder 12 may be vertically-oriented or horizontally-oriented, but is preferably horizontally-oriented as shown. More preferably, the cylinder 12 is horizontally-oriented along a first longitudinal axis X₁ (see FIG. 3). The cylinder 12 is preferably made of a metal, such as carbon steel or nickel. The cylinder 12 may also be made of a metal plated with carbon steel or nickel. More preferably, the cylinder 12 is made of A-515 or A-516 Grade 70 carbon steel. It will be understood by those skilled in the art that the evaporator 12 need not be in the form of a cylinder, and may take the form of any conventionally known vessel.

The cylinder 12 is preferably a pressurized vessel which is initially at least partially filled with HBr in the liquid phase (i.e., liquefied HBr gas under pressure). Preferably, the liquefied HBr is stored within the cylinder 12 under a vapor pressure of 220 to 317 psia and at a temperature of approximately 45° F. to 77° F. More preferably, the liquefied HBr is stored within the cylinder 12 under a vapor pressure of 290 to 317 psia and at a temperature of 68° F. to 77° F. Most preferably, the liquefied HBr gas is stored within the cylinder 12 under its own vapor pressure of about 297 psig (2,048 kPa absolute) at a temperature of approximately 70° F. (21.1° C.).

Referring to FIGS. 2-3, in the present embodiment, the cylinder 12 preferably has a length L of 5 to 10 feet, and more preferably approximately 7 feet, measured from the first end 12a to the second end 12b. The cylinder 12 preferably has a diameter D of 1 to 4 feet, and more preferably approximately 2.5 feet. The cylinder 12 preferably has an internal volume of 25 to 35 cubic feet, and more preferably approximately 27 cubic feet. However, it will be understood by those skilled in the art that the dimensions of the cylinder 12 may vary as necessary to suit the process applications of the end user.

The cylinder 12 is preferably at least partially filled with liquid phase HBr from a raw material source (not shown). The liquid HBr preferably initially occupies approximately 80% to 90%, and more preferably approximately 90%, of the internal volume of the cylinder 12. Preferably, the cylinder 12 is also cleaned prior to filling with liquid HBr.

At least a portion, and preferably substantially all, of the liquid phase HBr stored within the cylinder 12 evaporates to form gaseous HBr. The cylinder 12 preferably includes an outlet 26 for removing or permitting an outflow or release of gaseous HBr from the cylinder 12. Preferably, the outlet 26 is in fluid communication with an outlet conduit 24 equipped with a metered nozzle (not shown), a control valve 42 which can be selectively opened and closed, and/or one or more pressure and/or flow indicators (not shown), for measured and controlled feed of the gaseous HBr from the cylinder 12 (via the outlet 26) to the reactor 14. Accordingly, feed of the gaseous HBr to the reactor 14 commences after evaporation when the nozzle and/or valve 42 of the outlet conduit 24 is opened.

The system 10 further includes a heating assembly 16 for facilitating evaporation of the liquid HBr (see FIGS. 1 and 3). In one embodiment, the heating assembly 16 is preferably a tubular hose or delivery pipe 18 disposed at least slightly above the cylinder 12 and containing a fluid at initial temperatures sufficient to at least gently heat the cylinder 12. The fluid is applied to the cylinder 12 as gaseous HBr is released therefrom. More particularly, the heat transfer fluid delivery by the delivery pipe 18 raises the temperature of the exterior and then the interior of the cylinder 12. More preferably, the pipe 18 is horizontally-oriented above and aligned with a geometric center of the cylinder 12, such that the delivery pipe 18 extends along a second longitudinal axis X₂ which is spaced apart from and generally parallel to the first longitudinal axis X₁ of the cylinder 12. The delivery pipe 18 preferably delivers the heat transfer fluid contained therein to impinge upon the outer surface of the cylinder 12 for heating thereof.

The delivery pipe 18 is preferably disposed up to 36 inches (i.e., 3 feet) above the cylinder 12, and more preferably approximately 10 inches above the cylinder 12. It will be understood that the delivery pipe 18 may be spaced apart from the cylinder 12 by more than 36 inches, depending on the wind currents, as long as the output stream of the heat transfer fluid is not misdirected. The delivery pipe 18 is preferably made of stainless steel, carbon steel, poly carbon steel or painted carbon steel. Most preferably, the delivery pipe 18 is made of 304 stainless steel. It will be understood, however, that the delivery pipe 18 may be made of any material that is thermally compatible with the heat transfer fluid. Preferably, the delivery pipe 18 has an outer diameter of approximately ⅛ to 2 inches, and more preferably approximately ¼ to 1 inch. Most preferably, the delivery pipe 18 has an outer diameter of approximately ½ inches. Preferably, the length of the delivery pipe 18 is substantially equal to the length L of the cylinder 12 (i.e., approximately 7 feet). However, it will be understood that the length L of the delivery pipe 18 may be shorter or longer than the length L of the cylinder 12, as long as the delivery pipe 18 extends over at least a portion of the length L of the cylinder 12.

Referring to FIG. 1, in one embodiment, the delivery pipe 18 is supplied by a water source 44, and more preferably by an industrial water source 44, such that the heat transfer fluid for the cylinder 12 is water. The heat transfer fluid, preferably water, flowing through the delivery pipe 18 is maintained at an initial temperature of approximately 32° F. to 150° F., preferably up to approximately 77° F., more preferably approximately 45° F. to 77° F., and most preferably approximately 68° F. to 77° F. In one embodiment, the temperature of the heat transfer fluid is preferably approximately 70° F. It will be understood by those skilled in the art that upper limit of the temperature of the heat transfer fluid is not limited to the specific values recited herein. Instead, the upper limit of the heat transfer fluid temperature is limited only by the pressure rating of the safety relief device on the cylinder for the particular liquefied gas contained therein.

It will also be understood by those skilled in the art that the heated water need not be industrial water (though this is preferred for cost saving purposes), but rather may be supplied from any available water source. It will also be understood by those skilled in the art that another fluid with a thermal conductivity similar to water may be supplied to the delivery pipe 18 instead of water. Such alternative fluids preferably have thermal conductivities comparable to that of water. Examples of such alternative fluids includes propylene glycol, ethylene glycol, betaine, polyalkylene glycol, mineral oils, a silicone-based fluid (such as SYLTHERM™), any mixture thereof, or any mixture of one or more of these fluids with water.

Referring to FIG. 3, the delivery pipe 18 is preferably provided with at least one downwardly facing aperture 20, and more preferably with a plurality of spaced-apart and downwardly facing apertures 20 formed along at least a portion of the lower surface of the delivery pipe 18. More preferably, a plurality of spaced-apart and downwardly facing apertures 20 are formed along the entire length of the lower surface of the delivery pipe 18 that covers the cylinder 12. Each aperture 20 preferably has a diameter of approximately 1/32 to ⅛ inches, and preferably approximately 1/32 to ½ inches, and most preferably approximately 1/16 inches. Each aperture 20 is preferably spaced apart from an adjacent aperture by a span of approximately ½ to 4 inches, and more preferably approximately 1 to 3 inches, and most preferably approximately 2 inches. The delivery pipe 18 preferably includes approximately 32 apertures 20. It will be understood that the size, spacing and number of apertures 20 may vary depending on the specification of the particular application of use. At one or more locations between the water source 44 and the first aperture 20, the delivery pipe 18 may be equipped with one or more valves 46, such as ball valves, for controlling the flow of water to the cylinder 12.

The apertures 20 are preferably formed at least in a portion of the delivery pipe 18 facing the cylinder 12. Accordingly, when water flow through the delivery pipe 18 is initiated, the water passes through the apertures 20 and onto an exterior periphery 22a of the sidewall 22 of the cylinder 12. Preferably, the water flows through the delivery pipe 18 at a rate of approximately 5 to 10 gallons per minute, and more preferably approximately 8 gallons per minute. The flow of water through each aperture 20 is preferably approximately 0.1 to 0.4 gallons per minute, and more preferably approximately 0.2 gallons per minute. It will be understood that the flow rate of the heat transfer fluid (i.e., the water) through and out of the delivery pipe 18 may vary depending on the ambient temperature and the flow rate of the HBr.

More particularly, the water initially contacts the horizontally-oriented cylinder 12 at an upper portion 12c thereof which is proximate the delivery pipe 18. Upon contact with the cylinder 12, the water naturally flows (by gravity) from the upper portion 12c around the cylinder 12, and more preferably around both sides of the cylinder 12, toward an opposing lower portion 12d, which is distal from the delivery pipe 18 and proximate a ground surface 48, while following the arcuate contour of the exterior periphery 22 of the cylinder 12.

As such, the delivered heat transfer fluid directly contacts and heats a large portion of the surface area of the exterior periphery 22a of the sidewall 22 of the cylinder 12. More preferably, the delivered heat transfer fluid directly contacts substantially all of the surface area of the exterior periphery 22a of the sidewall 22 of the cylinder 12. Accordingly, over time, the delivered heat transfer fluid maintains the internal temperature of the cylinder 12 at approximately 45° F. to 77° F., and more preferably 68° F. to 77° F., and most preferably approximately 70° F. More particularly, the delivered heat transfer fluid maintains the liquid HBr which is remaining in the cylinder 12 and which has yet to be evaporated at a temperature of approximately 45° F. to 77° F., and more preferably 68° F. to 77° F., and most preferably approximately 70° F., thereby counteracting any cooling effect that naturally occurs within cylinder 12 as the evaporated gaseous HBr begins to be flowed to the reactor 14 from the cylinder 12. In turn, the evaporation rate of the liquid HBr remaining in the cylinder 12 is better controlled and uniformly maintained, such that the feed rate of gaseous HBr from the cylinder 12 to the reactor 14 is better controlled and uniformly maintained.

More particularly, the heating assembly 16 provides sufficient heating of the cylinder 12, even when ambient air temperatures approach 32° F., to effect evaporation of the liquid HBr contained therein, such that virtually (and preferably absolutely) no liquid HBr remains in the cylinder 12 after the vapor feeding process is completed. The heating assembly 16 also facilitates release of the gaseous HBr from the cylinder 12 to the reactor 14 at a target rate. Further, because the heating assembly 16 utilizes a heat transfer fluid at relatively low temperatures, there is no danger of overheating of the cylinder 12.

Referring to FIGS. 2-3, the system 10 further includes a scale assembly 28. The scale assembly 28 includes a base pad 30 including a weight sensor 50, a display (not shown) electrically connected to the weight sensor 50, a support plate 32 positioned on the base pad 30, and at least two spaced-apart cylinder supports 34 positioned on top of the support plate 32. The support plate 32 is preferably in the form of a tray or pan, such that the support plate 32 includes upwardly extending edges 36. The support plate 32 preferably has a sufficiently large length and width so as to encompass the cylinder 12. The support plate 32 may be made of carbon steel, stainless steel or any material that would structurally be capable of supporting the weight of the filled HBr cylinder 12. Preferably, the support plate 32 is made of carbon steel, and more preferably primed ¼ inch thick carbon steel. Each of the cylinder supports 34 preferably has a sufficient length so as to extend along at least a portion of the length L of the cylinder 12, and more preferably along at least 50% of the length L of the cylinder 12. The cylinder supports 34 may be made of carbon steel, stainless steel or any material that would structurally be capable of supporting the weight of the filled HBr cylinder 12. Preferably, the cylinder supports 34 are made of carbon steel, and more preferably 3 inch thick carbon steel.

For assembly of the scale assembly 28, the base pad 30 is positioned on a floor or ground surface 48, or other supporting surface, and the support plate 32 is secured to a top surface of the base pad 30. Preferably, the support plate 32 is attached to the base pad 30 by a single fastener (not shown), such as a bolt. However, it will be understood that multiple fasteners may be utilized and/or alternative conventionally known securing mechanisms may be utilized to attach the support plate 32 to the base pad 30. Next, the cylinder supports 34 are positioned on a top surface of the support plate 32, at least slightly interior of the edges 36. The cylinder supports 34 may simply rest on the support plate 32 or they may be attached thereto using any conventionally known securing mechanism.

In use, a cylinder 12 containing liquid HBr is placed directly or indirectly (i.e., one or more additional supports may be situated between the cylinder 12 and the cylinder supports 34) on top of the cylinder supports 34 of the assembled scale assembly 28. Then, the cylinder 12 is attached to a feed manifold for the reactor 14. As shown in FIG. 1, in one embodiment, multiple cylinders 12 are connected to the reactor 14 for feeding of HBr vapor thereto. Within the cylinder 12, the liquid HBr begins to evaporate to form gaseous HBr. Next, the nozzle and/or valve of the outlet conduit 24 extending from the outlet 26 of the cylinder 12 is opened so as to commence feeding of gaseous HBr to the reactor 14. Substantially simultaneously, or soon thereafter, fluid (i.e., water) flow through the delivery pipe 18 of the heating assembly 16 is initiated, such that heated water is delivered to the external periphery 22a of the cylinder 12, in order to heat and maintain the temperature of the cylinder 12 at approximately 70° F., maintain a target rapid evaporation rate of the liquid HBr and maintain a target rapid feed rate of the gaseous HBr from the cylinder 12 to the reactor 14.

Preferably, liquid HBr evaporates to form gaseous HBr at a rate of 75 to 200 kg/hr, and more preferably 100 to 175 kg/hr, and most preferably approximately 125 to 150 kg/hr. There is no accumulation of gaseous HBr in the cylinder 12. Thus, the gaseous HBr is delivered or fed to a reactor 14 at the same rate as the liquid HBr evaporates. That is, the gaseous HBr is preferably fed to the reactor 14 at a rate of 75 to 200 kg/hr, and more preferably 100 to 175 kg/hr, and most preferably approximately 125 to 150 kg/hr. However, it will be understood by those skilled in the art that the evaporation and delivery/feed rates may vary based on the end application, the initial volume of liquid HBr in the cylinder 12, the size of the cylinder 12, the overall volume of the cylinder 12, and the like.

The heat transfer fluid (i.e., water) travels from the upper portion 22a of the cylinder 12 to the bottom portion 22b proximate the cylinder supports 34. The upwardly extending edges 36 of the supporting plate 32 contains the delivered water and directs it toward a drain 38, preferably via one or more rigid and/or flexible pipes or hoses 40 (see FIG. 1). The drained and collected water may then be disposed of or may be recycled and returned to the water source 44 for repeated application to the cylinder 12.

The heat transfer fluid is delivered to the cylinder 12 and the outlet 26 remains open until all of the gaseous HBr has been transferred out of the cylinder 12 and into the reactor 14. To completely empty the cylinder 12, this process typically takes approximately 7 to 9 hours and more preferably approximately 7.5 hours. However, it will be understood that the overall process time is dependent upon the initial volume of liquid HBr in the cylinder 12, the overall volume of the cylinder 12, the evaporation rate and the feed rate. Also, the overall process time is dependent upon whether a cylinder 12 is being fully or only partially emptied.

Preferably, completion of the process, and more particularly, completion of the feeding of the gaseous HBr can be determined by reference to the scale assembly 28. Specifically, assuming that the starting empty weight of the cylinder 12 is known or predetermined, an operator can reference the display of the scale assembly 28, which will initially indicate a starting weight of the cylinder 12, when the cylinder 12 is filled with liquid HBr. The scale assembly 28 will then indicate a gradually decreasing weight, as the liquid HBr is evaporated to form gaseous HBr and the gaseous HBr is transferred out of the cylinder 12. The operator can confirm that all or substantially all of the gaseous HBr has been transferred out of the cylinder 12 when the scale assembly 28 indicates an end weight that is generally equal to the predetermined starting empty weight of the empty cylinder 12. Preferably, the process is completed when the end weight is within ±5% of the predetermined starting empty weight of the cylinder 12. Also, the temperature and/or the application or flow rate of the heat transfer fluid may be adjusted based on measurements from the scale assembly 28.

It will be appreciated by those skilled in the art that changes could be made to the embodiment described above without departing from the broad inventive concepts thereof. Also, based on this disclosure, a person of ordinary skill in the art would further recognize that the relative proportions of the components illustrated could be varied without departing from the spirit and scope of the invention. It is understood, therefore, that this invention is not limited to the particular embodiment disclosed, but it is intended to cover modifications within the spirit and scope of the present invention as defined by the appended claims.

We claim:

1. A method for releasing an anhydrous gas in a gas phase at a target rate, the method comprising the steps of:
obtaining a vessel at least partially filled with the anhydrous gas, the anhydrous gas being at least partially in a liquid phase, the vessel having an outlet for releasing the anhydrous gas in the gas phase;
releasing the anhydrous gas from the vessel through the outlet in the gas phase;
applying a heat transfer fluid having a temperature of 32° F. to 150° F. to an exterior surface of the vessel during the releasing step, such that the anhydrous gas in the liquid phase is evaporated and the anhydrous gas in the gas phase is released at the target rate; and
measuring a starting weight of the vessel and an end weight of the vessel to monitor the releasing of the anhydrous gas in the gas phase.

2. The method of claim 1, wherein substantially all of the anhydrous gas contained in the vessel in the liquid phase is released from the vessel in the gas phase.

3. The method of claim 1, wherein the target rate is 100 kg/hr to 200 kg/hr.

4. The method of claim 1, wherein the anhydrous gas is a halogen gas, a CO₂, a H₂, a O₂, a N₂, and a HS.

5. The method of claim 4, wherein the anhydrous gas is hydrogen bromide and the heat transfer fluid is water having a temperature of 45° F. to 77° F.

6. The method of claim 5, wherein the heat transfer fluid has a temperature of 68° F. to 77° F., and the target rate is 125 to 150 kg/hr.

7. The method of claim 1, further comprising adjusting at least one of the temperature and a rate of application of the heat transfer fluid based on measurements from the measuring step.

8. The method of claim 1, wherein the heat transfer fluid is applied such that the applied heat transfer fluid initially contacts an upper portion of the vessel and subsequently travels in a downward direction via gravity toward a bottom portion of the vessel.

9. An evaporator and feed system for releasing an anhydrous gas in a gas phase at a target rate, comprising:
a vessel at least partially filled with the anhydrous gas, the anhydrous gas being at least partially in a liquid phase, the vessel having an outlet for releasing the anhydrous gas in the gas phase;
a scale assembly including a weight sensor, the vessel being positioned on and supported by a surface of the scale assembly, such that the scale assembly measures a weight of the vessel; and
a heating assembly for applying a heat transfer fluid having a temperature of 32° F. to 150° F. to an exterior surface of the vessel during the releasing step, such that the anhydrous gas in the liquid phase is evaporated and the anhydrous gas in the gas phase is released at the target rate.

10. The evaporator and feed system of claim 9, wherein:
the vessel is a cylinder having a first upper portion and an opposing second lower portion; and
the heating assembly comprises a delivery pipe positioned proximate the first upper portion of the cylinder, the delivery pipe having at least one aperture and the heat transfer fluid flowing therethrough, wherein the heat transfer fluid passes through the at least one aperture, contacts the first upper portion of the cylinder, and travels in a downward direction via gravity from the first upper portion of the cylinder toward the second lower portion of the cylinder.

11. The evaporator and feed system of claim 10, wherein the delivery pipe comprises a plurality of the apertures spaced-apart along a length of the pipe.

12. The evaporator and feed system of claim 11, wherein the cylinder is horizontally-oriented along a first longitudinal axis, and the delivery pipe is horizontally-oriented along a second longitudinal axis, and wherein the delivery pipe is positioned above the cylinder and is spaced apart from and extending parallel to the first longitudinal axis.

13. The evaporator and feed system of claim 9, further comprising a reactor in communication with the vessel, the anhydrous gas flowing from the outlet of the vessel in the gas phase into the reactor.

14. The evaporator and feed system of claim 9, further comprising a drain for receiving the heat transfer fluid which has passed over the vessel.

15. The evaporator and feed system of claim 14, wherein the scale assembly includes a support plate configured to direct the heat transfer fluid which has passed over the vessel toward the drain.

16. The evaporator and feed system of claim 9, wherein scale assembly includes a pair of spaced-apart supports configured to support the vessel.

17. The evaporator and feed system of claim 9, wherein the target rate is 100 kg/hr to 200 kg/hr.

18. The evaporator and feed system of claim 9, wherein the anhydrous gas is a halogen gas, a CO₂, a H_{z}, a N₂, and a HS.

19. The evaporator and feed system of claim 18, wherein the anhydrous gas is hydrogen bromide and the heat transfer fluid is water having a temperature of 45° F. to 77° F.

20. The evaporator and feed system of claim 19, wherein the heat transfer fluid has a temperature of 68° F. to 77° F., and the target rate is 125 kg/hr to 150 kg/hr.
